(19) United States
(12) Patent Application Publication
(10) Pub. No.: US 2015/0072319 A1
(43) Pub. Date: Mar. 12, 2015

(54) SYSTEM AND METHOD FOR INTEGRATED MARINE AND PROCESS SIMULATION

(71) Applicants: NEERAJ ZAMBARE, Houston, TX (US); SAM HEMADA, Houston, TX (US)

(72) Inventors: NEERAJ ZAMBARE, Houston, TX (US); SAM HEMADA, Houston, TX (US)

(21) Appl. No.: 14/462,433

(22) Filed: Aug. 18, 2014

Related U.S. Application Data
(60) Provisional application No. 61/867,104, filed on Aug. 18, 2013.
(60) Provisional application No. 61/906,033, filed on Nov. 19, 2013.

(51) Int. Cl. G09B 9/00; E21B 49/00

(52) U.S. Cl. CPC G09B 9/00; E21B 49/003
USPC 434/126; 434/219; 702/9

(57) ABSTRACT

A simulation system for marine operator training for operation of a floating oil and gas drilling or production facility or platform, or similar marine facilities. The simulation environment combines a process model with equipment coordinates to calculate center-of-gravity, a ballast and bilge model, an emulation or copy of a field control system, actual Distributed Control System (DCS) operator screens, and a load management advisory program. The simulation environment is used to train and evaluate individuals for standard marine operating procedures, as well as training for emergency situations, such as hurricane shutdown and start-up, alarms monitoring and control resulting from instrument failures, damaged mooring lines, and damaged ballast compartments

This application claims benefit of and priority to U.S. Provisional Application No. 61/867,104, filed Aug. 18, 2013, by Neeraj Zambare, et al., and U.S. Provisional Application No. 61/906,033, filed Nov. 19, 2013, by Neeraj Zambare, et al., and is entitled to those filing dates for priority, in whole or in part. The specifications, figures, appendices, and complete disclosure of U.S. Provisional Application Nos. 61/867,104 and 61/906,033 are incorporated herein in their entireties by specific reference for all purposes.

### FIELD OF INVENTION

This invention relates generally to oil and gas well drilling and production, and related operations. More particularly, this invention relates to a computer-implemented system for integrating marine and process simulation of a floating oil and gas drilling or production facility.

### SUMMARY OF INVENTION

In various exemplary embodiments, the present invention comprises a simulation environment for marine operator training (i.e., operation of a floating oil and gas drilling or production facility or platform, or similar marine facilities). The simulation environment combines a process model with equipment coordinates to calculate center-of-gravity, a ballast and bilge model, an emulation or copy of a field control system, actual Distributed Control System (DCS) operator screens, and a load management advisory program. The simulation environment is used to train and evaluate individuals for standard marine operating procedures, as well as training for emergency situations, such as hurricane shutdown and start-up, alarms monitoring and control resulting from instrument failures, damaged mooring lines, and damaged ballast compartments (e.g., due to a collision or similar accident).

In several embodiments, the individual being trained (e.g., student, or marine operator), interacts with several components, which may reside on a marine operator server. The control system operator human-machine interface (HMI) is used to issue valve open/close commands, and pump start/stop commands. The marine data display software is used to display data from the Environment and Facilities Monitoring System (EFMS). This data includes wind speed and direction, surface current speed and direction, heading, mooring line tension, and the like. The student also has access to the advisory load management and mooring system. This system can be taken off-line and used as an advisory system for ballasting or mooring control.

In several embodiments, there are eight additional components used for simulation calculations and processing, including (1) a Dynamic Process Model (DPM) for the hull ballast and bilge system, (2) a Hydrostatic Marine Model (HMM) to calculate various vessel parameters, (3) an OPC (Open Platform Communications protocol) Server for managing data transfer between the DPM and the HMM, (4) an EFMS Sensor

Simulator, (5) an OPC Server for managing EFMS sensor data transfer, (6) an EFMS, (7) an OPC Server for managing EFMS load management data transfer, and (8) an OPC Server for managing Control System data transfer. These components may reside on a separate engineering server, on the server with the various HMI components, or on several separate servers.

The DPM is a central component of the present invention, and is the process model for the hull ballast and bilge system, including all tanks, pumps, eductors, and piping. It can include topside processes, as well. It receives input from the instructor (such as scenario parameters) and is configurable from the HMI to set wind direction, wind speed, wave frequency, wave amplitude, air temperature, and free deck loads.

Equipment position on the vessel is described using x, y, z coordinates. In one embodiment, the relative elevations of equipment is determined based on the vessel's position, with equipment movement in the z direction. In another embodiment, the simulation encompasses movement of the process equipment in all 3 directions.

The DPM also can include the effects of inclination on liquid levels resulting in incorrect level measurements, efficiency problems in heat exchangers and distillation columns (liquid level changes directly change the area of contact, resulting in reduced tray efficiency), head changes for pumps that result in pump performance variation and the possibility of liquid carryover or gas breakthrough in vessels. This applies to all floating production units (FPUs).

The HMM receives data about deckloads, environment, ballast, bilge and mooring line length from the DPM through the OPC Server, and calculates vessel inclination, draft, and mooring line tension.

The EFMS Sensor Simulator simulates any field sensors not available as input from the instructor or the DPM. These sensors include, but are not limited to, ambient pressure, humidity, and air gap.

The EFMS collects facility environment data and process data from control systems, such as tank levels, mooring line tensions, draft, and inclination.

In yet another embodiment, the present invention comprises a real-time instrument fault detection system and method. This may be incorporated into the simulation model of a production separator system, or installed in an operational system.

### BRIEF DESCRIPTION OF THE DRAWINGS

FIG. 1 shows a diagram of an integrated simulation environment in accordance with an exemplary embodiment of the present invention.

FIG. 2 is a diagram of a distillation column with liquid level effects.

FIG. 3 is a diagram of a pump with hydraulic effects.

FIG. 4 shows an example of an interface screen.

FIG. 5 shows an example of a separate real time model.

FIG. 6 shows an example of a residual chart.

FIG. 7 shows an example of an active alarm screen.

### DETAILED DESCRIPTION OF EXEMPLARY EMBODIMENTS

### Computing Environment Context

The following discussion is directed to various exemplary embodiments of the present invention, particularly as implemented into a hardware and software architecture for training and simulation. However, it is contemplated that this invention may provide substantial benefits when implemented in systems according to other architectures, and that some or all of the benefits of this invention may be applicable in other applications.

For example, while the embodiments of the invention may be described herein in connection with wells and drilling facilities used for oil and gas exploration and production, the invention also is contemplated for use in connection with other wells, including, but not limited to, geothermal wells, disposal wells, injection wells, and many other types of wells. One skilled in the art will understand that the examples disclosed herein have broad application, and that the discussion of any particular embodiment is meant only to be exemplary of that embodiment, and not intended to suggest that the scope of the disclosure, including the claims, is limited to that embodiment.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or a combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

In addition, while this invention is described in connection with a multiple level hardware and software architecture system, in combination with drilling equipment and human operators, it is contemplated that several portions and facets of this invention are separately and independently inventive and beneficial, whether implemented in this overall system environment or if implemented on a stand-alone basis or in other system architectures and environments. Those skilled in the art having reference to this specification are thus directed to consider this description in such a light.

### Integrated Marine and Process Simulation

In one exemplary embodiment, the present invention comprises a simulation environment for marine operator training (i.e., operation of a floating oil and gas drilling or production facility or platform, or similar marine facilities). The simulation environment combines a process model with equipment coordinates to calculate center-of-gravity, a ballast and bilge model, an emulation or copy of a field control system, actual Distributed Control System (DCS) operator screens, and a load management advisory program. The simulation environment is used to train and evaluate individuals for standard marine operating procedures, as well as training for emergency situations, such as hurricane shutdown and start-up, alarms monitoring and control resulting from instrument failures, damaged mooring lines, and damaged ballast compartments (e.g., due to a collision or similar accident).

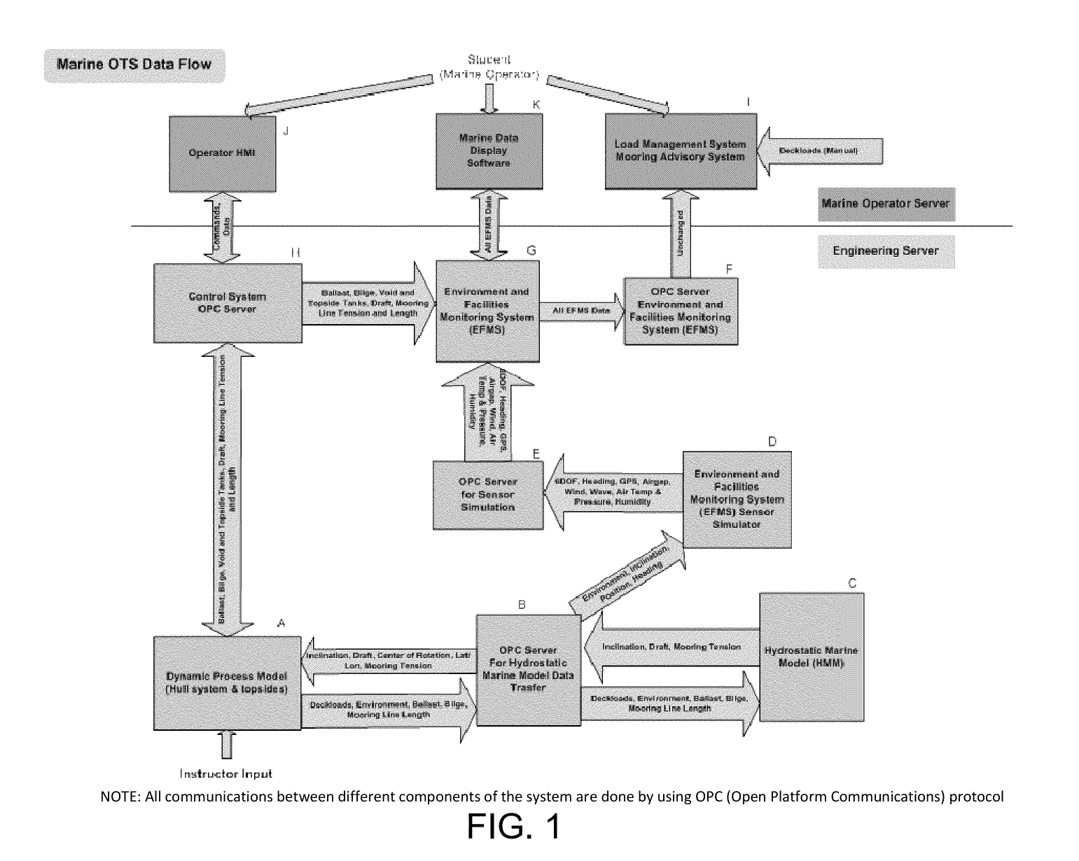

FIG. 1 shows an exemplary embodiment of the data flow between various components of a marine operator training system. The individual being trained (e.g., student, or marine operator), interacts with several components, which may reside on a marine operator server. The control system operator human-machine interface (HMI) (Component J) is used to issue valve open/close commands, and pump start/stop commands. In addition to the student/operator station, an instructor station also may be provided to provide input or otherwise control the simulation or simulation scenario.

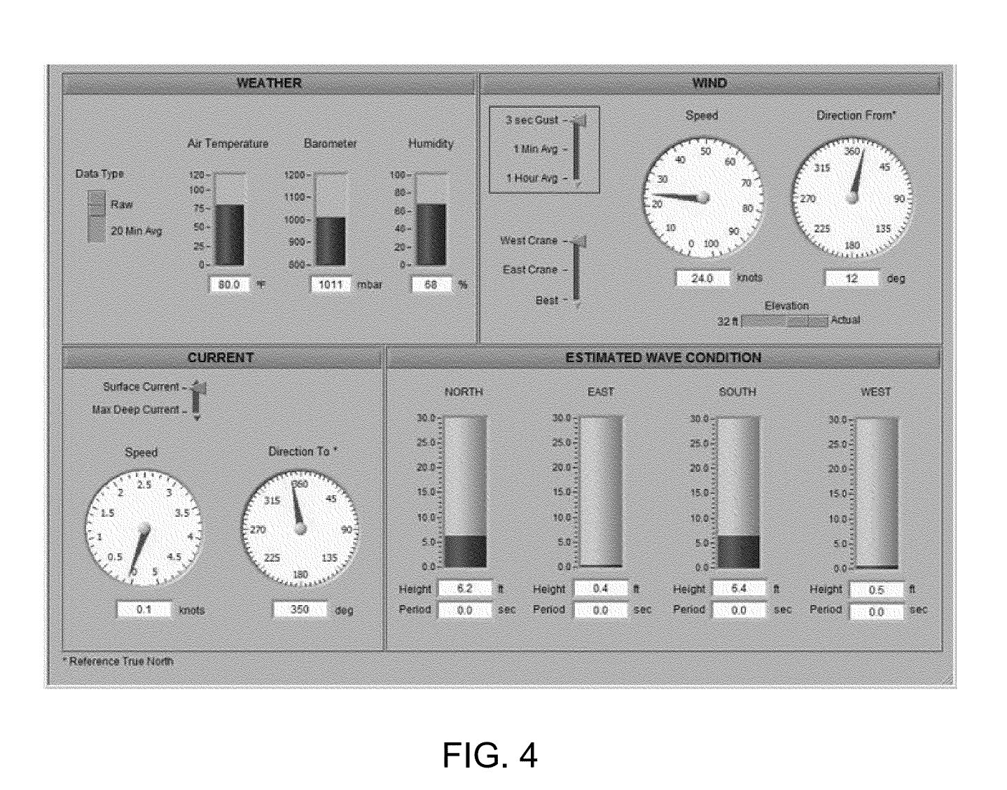

The marine data display software (Component K) is used to display data from the Environment and Facilities Monitoring System (EFMS) (Component G). This data includes wind speed and direction, surface current speed and direction, heading, mooring line tension, and the like. The student also has access to the advisory load management and mooring system (Component I). This system can be taken off-line and used as an advisory system for ballasting or mooring control. An example of an interface screen is shown in FIG. 4.

In the embodiment shown, there are eight additional components used for simulation calculations and processing, including (1) a Dynamic Process Model (DPM) for the hull ballast and bilge system (Component A), (2) a Hydrostatic Marine Model (HMM) to calculate various vessel parameters (Component C), (3) an OPC (Open Platform Communications protocol) Server (Component B) for managing data transfer between the DPM and the HMM, (4) an EFMS Sensor Simulator (Component D), (5) an OPC Server for managing EFMS sensor data transfer (Component E), (6) an EFMS (Component G), (7) an OPC Server for managing EFMS load management data transfer (Component F), and (8) an OPC Server for managing Control System data transfer. These components may reside on a separate engineering server, on the server with the various HMI components, or on several separate servers.

The DPM is a central component of the present invention, and is the process model for the hull ballast and bilge system, including all tanks, pumps, eductors, and piping. It can include topside processes, as well. It receives input from the instructor (such as scenario parameters) and is configurable from the HMI to set wind direction, wind speed, wave frequency, wave amplitude, air temperature, and free deck loads. Detailed information about an embodiment of a ballast process system model is provided in the appendix hereto.

Equipment position on the vessel is described using x, y, z coordinates. In one embodiment, the relative elevations of equipment is determined based on the vessel's position, with equipment movement in the z direction. In another embodiment, the simulation encompasses movement of the process equipment in all 3 directions. Additional information about x, y, z coordinates is provided in the appendix hereto.

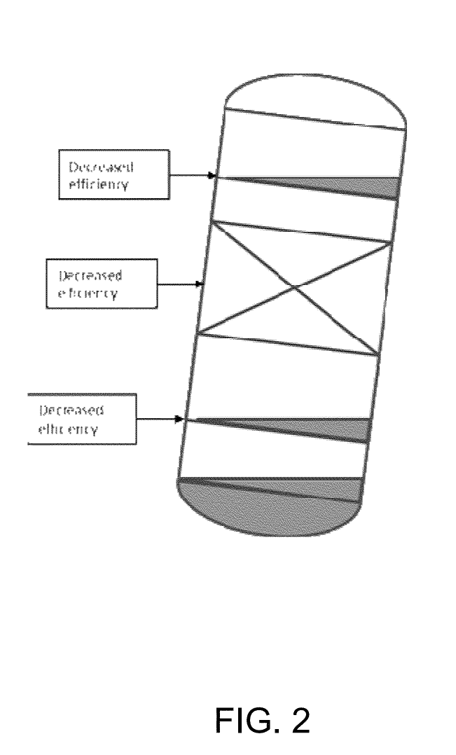

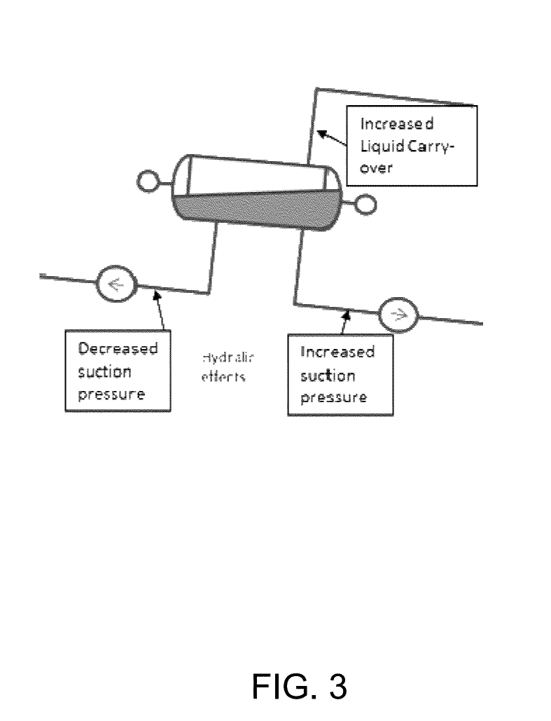

The DPM also can include the effects of inclination on liquid levels resulting in incorrect level measurements, efficiency problems in heat exchangers and distillation columns (liquid level changes directly change the area of contact, resulting in reduced tray efficiency), head changes for pumps that result in pump performance variation and the possibility of liquid carryover or gas breakthrough in vessels, as seen in FIGS. 2 and 3. This applies to all floating production units (FPUs).

The HMM receives data about deckloads, environment, ballast, bilge and mooring line length from the DPM through the OPC Server, and calculates vessel inclination, draft, and mooring line tension.

The EFMS Sensor Simulator simulates any field sensors not available as input from the instructor or the DPM. These sensors include, but are not limited to, ambient pressure, humidity, and air gap. The EFMS collects facility environment data and process data from control systems, such as tank levels, mooring line tensions, draft, and inclination.

Additional details on several embodiments of a ballast process system model, hydrostatic marine model, instructor station, and other elements may be found in the Appendix to the Specification, which is attached hereto and incorporated herein.

In yet another embodiment, the present invention comprises a real-time instrument fault detection system and method. This may be incorporated into the simulation model of a production separator system, or installed in an operational system. This provides early event warning of instrument faults, which can prevent unplanned production shut-downs. The system provides for real-time identification of fault detection conditions of all level transmitters located on the production separator for a production facility (e.g., offshore production facility).

In several embodiments, the instrument fault detection method is based on calculations over three different time intervals. The time interval lengths can be tuned based on field condition observation to minimize false or nuisance alarms. Shorter time intervals may be used to detect larger size faults, while longer intervals are useful for detecting smaller size faults, or faults that grow over a substantial period of time.

In some exemplary embodiments, two methods are employed to ascertain a fault in a level transmitter on a separator. One method is based on redundant level measurements on the separator (e.g., one measurement is used for control, and the other is used for safety). The other method employs a first principles dynamic process model with complete mass and energy balance to realize any gain/loss of mass which in turn points to a fault. The overall objective is to detect the level transmitter fault far enough in advance to allow corrective action and avoid any future process shutdown caused due to this failure.

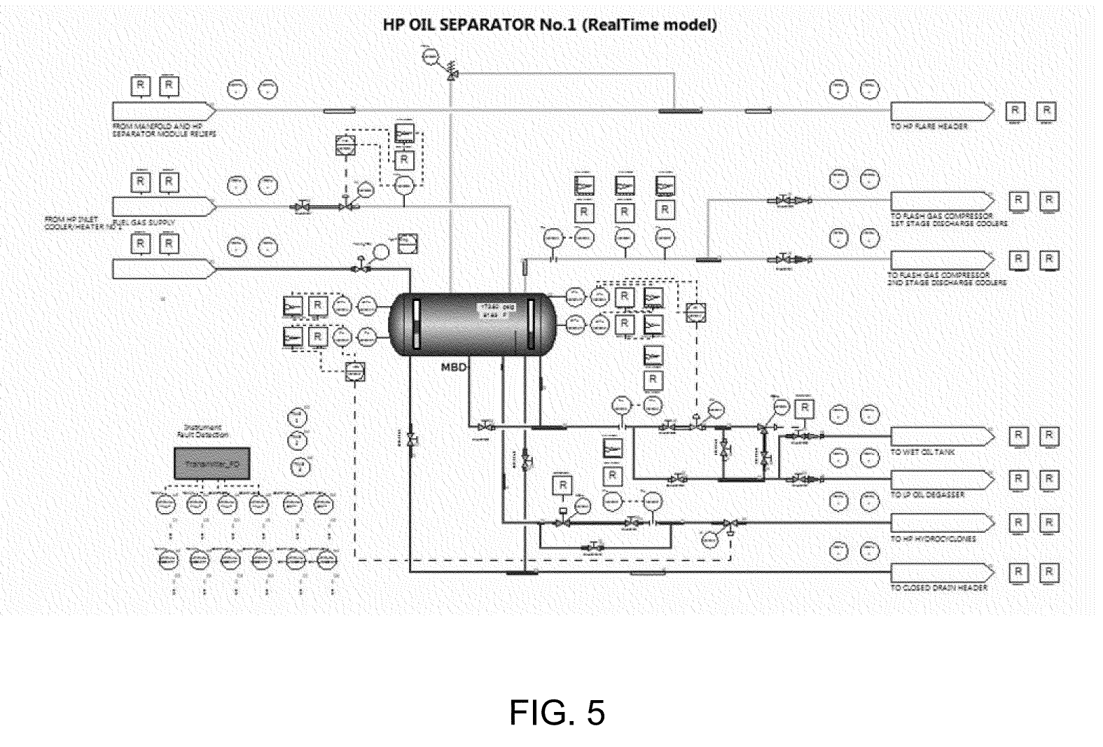

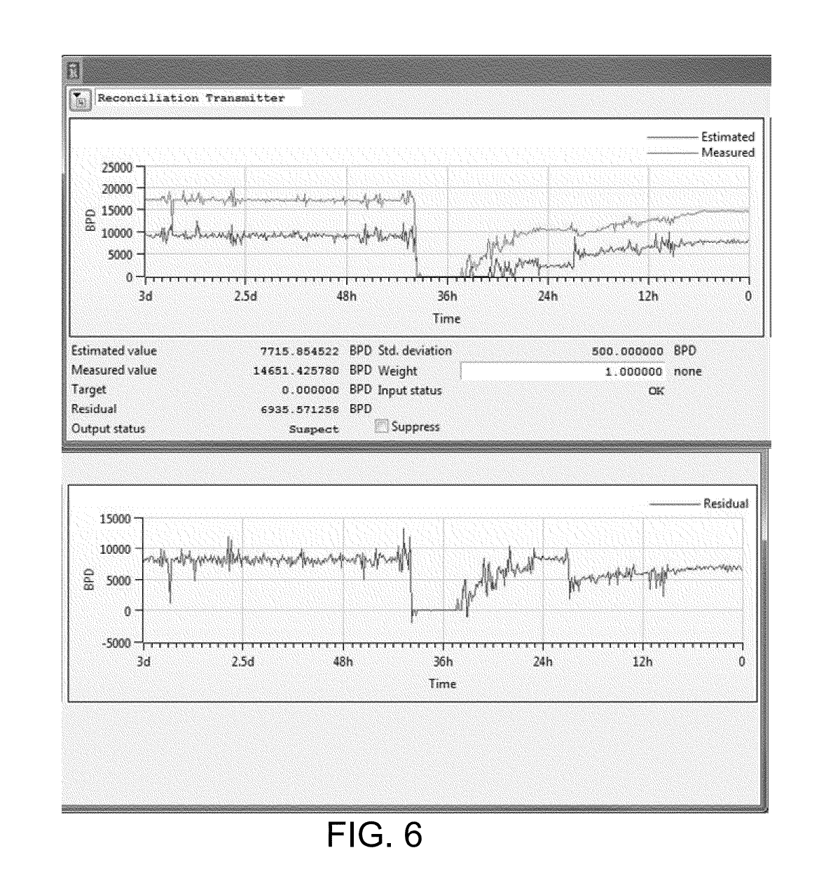

In several examples, a real-time dynamic simulation model of the separator unit is built, as seen in FIG. 5. “Real-time” in this context indicates that the dynamic model is running 24 hours, 7 days a week at a speed equal to clock time. For each measured data point (or a data point derived from more than one available measurement, such as accumulated value of a measured data point over time), a residual is calculated as the difference between the measured value received from the field and the estimated value from the model (as seen in FIG. 6). A time averaged value of each residual is monitored over three different time intervals (small, medium, and large). The time interval lengths can be calibrated based on field condition observations to minimize nuisance alarms.

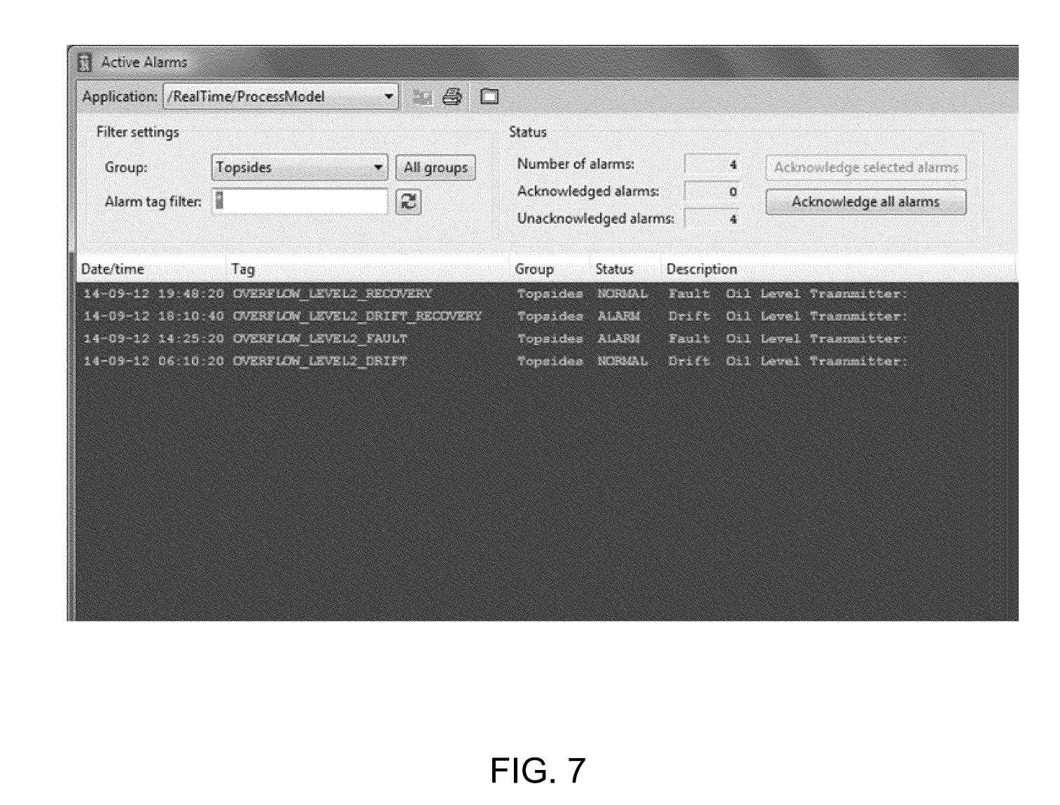

Small interval is used to detect larger size faults; medium interval is used to detect medium size faults; whereas large interval is used to detect very small faults such as a transmitter drift which grows over a long period of time (more than one day). Existence of a fault and identification of the faulty level transmitter is achieved by monitoring a combination of the following residuals:
1. The residual of the difference of two types of level transmitter readings between the field data and the estimated value from real time models. This inherently also takes into account any statistical variation between the two redundant field measurements as well.
2. The residual of the accumulated mass (oil or water) leaving the separator between the field data and the estimated value from real time model. Fault conditions can be shown to a user on a screen or user interface, or other form of warning may be given (e.g., light, alarm sound). An example of a screen showing transmitter status, and fault conditions, is shown in FIG. 7.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for simulation of operations on a floating marine facility, comprising:
one or more distributed control system operator stations, each station comprising one or more operator screens and at least one human-machine interface;
one or more computer servers, each server with a processor or microprocessor coupled to a memory; and
a plurality of simulation processing components installed on said one or more computer servers, said simulation processing components comprising:
a dynamic process model for a hull ballast and bilge system;
a hydrostatic marine model for calculating marine facility parameters; and
an environment and facilities monitoring system and sensor simulator.

2. The system of claim 1, wherein the dynamic process model for the hull ballast and bilge system comprises tanks, pumps, eductors, and piping in the ballast and bilge system.

3. The system of claim 1, wherein the dynamic process model receives input from the one or more distributed control system operator stations to set ballast and bilge system parameters.

4. The system of claim 3, wherein the ballast and bilge system parameters comprise wind direction, wind speed, wave frequency, wave amplitude, air temperature, and free deck loads.

5. The system of claim 1, wherein equipment position on the simulated floating marine facility is described using x, y, z coordinates.

6. The system of claim 5, wherein the relative elevations of equipment is determined based on the floating marine facility position.

7. The system of claim 6, wherein the elevation of equipment is determined based on equipment movement in the vertical (z) direction.

8. The system of claim 6, wherein the elevation of equipment is determined based on equipment movement in all directions.

9. The system of claim 1, wherein the dynamic process model comprises compensating for the effect of inclination on liquid levels in equipment.

10. The system of claim 1, wherein the hydrostatic marine model receives input data from the dynamic process model for the hull ballast and bilge system, and calculates floating marine facility inclination, draft, and mooring line tension.

11. The system of claim 1, wherein the floating marine facility is a floating petroleum drilling facility or platform.

12. The system of claim 1, wherein the floating marine facility is a floating petroleum production facility or platform.

13. The system of claim 1, further comprising a real-time instrument fault detection system.

14. A system for detecting instrument faults in a separator unit in real-time, comprising:
a separator unit with a plurality of transmitters;
a dynamic simulation model of the separator unit, wherein the simulation model runs in real time;
a computing device with a microprocessor, said microprocessor programmed to calculate a residual based on the difference between at least one measured value received from one or more of said plurality of transmitters and a corresponding estimated value determined by said dynamic simulation model.

15. The system of claim 14, wherein a plurality of residual are calculated over time.

16. The system of claim 15, wherein the microprocessor is further programmed to determine a time-averaged value of each residual.

17. The system of claim 16, wherein the time-averaged value of each residual is monitored over three different time intervals.

18. The system of claim 17, wherein the microprocessor is further programmed to detect a fault by monitoring the residual of the difference of two types of level transmitter readings.

19. The system of claim 18, wherein the microprocessor is further programmed to detect a fault by monitoring the residual of accumulated mass leaving the separator.
